(19) United States
(12) Patent Application Publication
(10) Pub. No.: US 2020/0209940 A1
(43) Pub. Date: Jul. 2, 2020

(54) INFORMATION PROCESSING SYSTEM AND RELAY DEVICE

(71) Applicant: FUJITSU CLIENT COMPUTING LIMITED, Kanagawa (JP)

(72) Inventor: Shinsuke Murakami, Kawasaki (JP)

(73) Assignee: FUJITSU CLIENT COMPUTING LIMITED, Kanagawa (JP)

(21) Appl. No.: 16/669,764

(22) Filed: Oct. 31, 2019

(30) Foreign Application Priority Data
Dec. 28, 2018 (JP) 2018-248669

(51) Int. Cl. G06F 1/3209; H04L 12/12

(52) U.S. Cl. CPC G06F 1/3209; H04L 12/12

(57) ABSTRACT

An information processing system includes a plurality of information processing devices, a relay device, and a local area network (LAN) controller. The plurality of information processing devices each include a processor. The relay device connects the plurality of information processing devices via an expansion bus and relays communication between the plurality of information processing devices. The local area network (LAN) controller is operatively coupled to at least one of the plurality of information processing devices and connectable to a LAN. The relay device includes a power supply controller that controls supply of power to the plurality of information processing devices and performs start-up control of the plurality of information processing devices in response to receiving a wake-on-LAN instruction from the LAN via the LAN controller.

### CROSS-REFERENCE TO RELATED APPLICATIONS

This application is based upon and claims the benefit of priority from Japanese Patent Application No. 2018-248669, filed Dec. 28, 2018, the entire contents of which are incorporated herein by reference.

### TECHNICAL FIELD

The present disclosure relates generally to an information processing system and a relay device.

### BACKGROUND

There has been known a technique that performs parallel computation using a plurality of computers (arithmetic devices), and for example, there has been proposed an information processing system that exchanges data between the computers using an Ethernet (registered trademark) line.

When such an information processing system is started up via a network, a wake on local area network (wake-on-LAN: WoL) is used in the related art.

When the wake-on-LAN (WoL) is performed, if a LAN controller receives a magic packet which is a wake-on-LAN (WoL) request packet, the LAN controller outputs a Wake signal to a processor constituting an information processing device, which is connected to a wake-on-LAN (WoL) signal of the LAN controller, to start start-up processing.

In this way, the processor is configured to control a power supply unit to supply power and release a power saving mode.

However, in the case of an information processing system configuration in which a plurality of information processing devices are connected via a bridge board, since a processing procedure differs between when start-up is performed by pressing a power button and when start-up is performed by the wake-on-LAN (WoL) via a LAN, it is likely that an information processing system not be started up or the information processing system may become unstable depending on a combination and the like of the information processing devices.

### SUMMARY

According to an aspect of the present disclosure, an information processing system includes a plurality of information processing devices, a relay device, and a local area network (LAN) controller. The plurality of information processing devices each include a processor. The relay device is able to connect the plurality of information processing devices via an expansion bus and relays communication between the plurality of information processing devices. The local area network (LAN) controller is operatively coupled to at least one of the plurality of information processing devices and connectable to a LAN. The relay device includes a power supply controller that controls supply of power to the plurality of information processing devices and performs start-up control of the plurality of information processing devices in response to receiving a wake-on-LAN instruction from the LAN via the LAN controller.

### BRIEF DESCRIPTION OF THE DRAWINGS

FIG. 1 is a schematic configuration block diagram mainly illustrating a connection configuration of a communication system in an information processing system of an embodiment;

FIG. 2 is a schematic configuration block diagram mainly illustrating a connection configuration of a power supply system in the information processing system of the embodiment;

FIG. 3 is an explanatory diagram of a software configuration example of a platform;

FIG. 4A is a diagram (part 1) for explaining an example of a processing sequence flowchart at the time of start-up processing via a LAN of an embodiment; and

FIG. 4B is a diagram (part 2) for explaining the example of the processing sequence flowchart at the time of the start-up processing via the LAN of the embodiment.

### DETAILED DESCRIPTION

Hereinafter, an embodiment according to the present relay device and the present information processing system will be described with reference to the drawings. However, the following embodiment is merely an example and there is no intention to exclude application of various modification examples and technologies not explicitly described in the embodiment. That is, the present embodiment can be implemented with various modifications without departing from the scope thereof. Furthermore, each drawing is not intended to include only components illustrated in the drawing and is able to include other functions and the like.

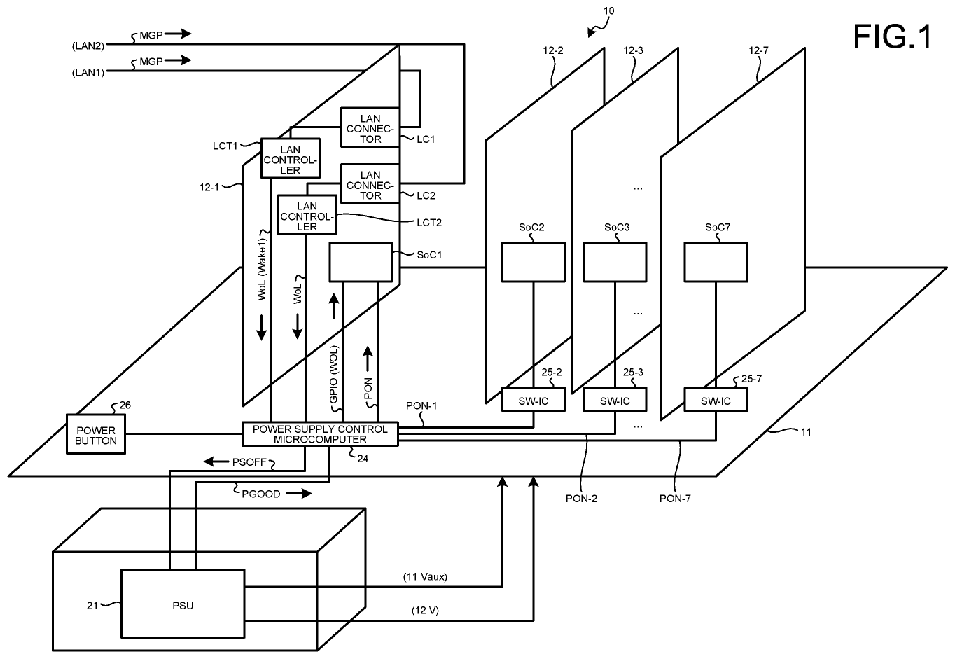

FIG. 1 is a schematic configuration block diagram mainly illustrating a connection configuration of a communication supply system in an information processing system of an embodiment.

The following description will be given for a case where a PCI express (PCIe) [registered trademark] is used as an example of an expansion bus.

An information processing system 10 roughly includes a bridge board 11, a plurality of platforms 12-1 to 12-7, and a power supply unit (PSU) 21.

The bridge board 11 roughly includes a power supply control microcomputer 24, switching ICs 25-2 to 25-7, and a power button 26.

The power supply unit 21 converts AC power supplied from a commercial power supply into DC power having predetermined voltages (for example, 11 V that is supplied at all times and becomes standby power, 12 V supplied when a power saving mode is released, and the like), and supplies the DC power to each element.

The power supply control microcomputer 24 controls the supply of power to a control unit SoC (system-on-a-chip) 1 as a SoC constituting the platform (root complex) 12-1 and controls the supply of the power to the platforms (end points) 12-2 to 12-7 via the switching ICs 25-2 to 25-7 in response to an operation of the power switch 26.

The power supply control microcomputer 24 outputs a power control signal PSOFF for controlling power supply and shut-off to the power supply unit 21.

On the other hand, the power supply unit 21 outputs a state signal PSGOOD, which indicates that the supply of power is possible or good, to the power supply control microcomputer 24.

The switching IC 25-2 to the switching IC 25-7 are placed under the control of the power supply control microcomputer 24, and perform power supply and shut-off with respect to control units SoC2 to SoC7 as SoCs constituting the platforms 12-2 to 12-7, to which the switching ICs 25-2 to 25-7 are connected, on the basis of power supply and shut-off signals PON_2 to PON_7 output from the power supply control microcomputer 24.

The platform 12-1 includes a LAN connector LC1 connected to a first local area network (LAN) LAN1, a LAN connector LC2 connected to a second local area network (LAN2), a LAN controller LCT1 connected to the LAN connector LC1 to perform communication control via the local area network LAN1, a LAN controller LCT2 connected to the LAN connector LC2 to perform communication control via the local area network LAN2, and the control unit SoC1 that controls the entire platform 12-1.

The platforms 12-2 to 12-7 include the control units SoC2 to SoC71, which control the platforms 12-2 to 12-7, respectively.

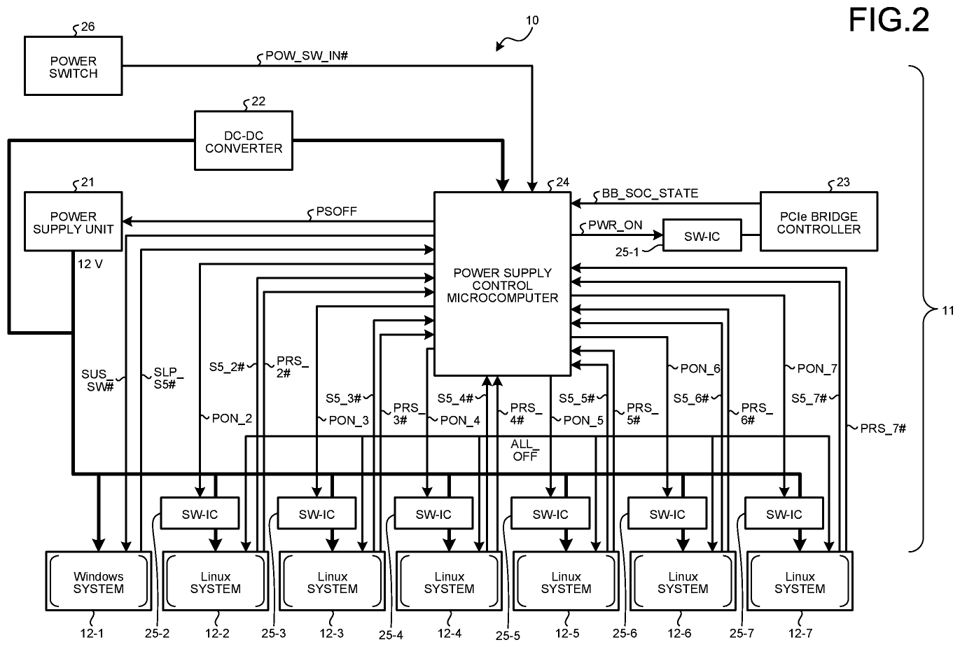

FIG. 2 is a schematic configuration block diagram mainly illustrating a connection configuration of a power supply system in the information processing system of the embodiment.

The bridge board 11 includes a DC-DC converter 22, a PCIe bridge controller 23, and a switching IC 25-1, in addition to the aforementioned power supply unit 21, power supply control microcomputer 24, switching ICs 25-1 to 25-7, and power button switch 26.

The DC-DC converter 22 converts power supplied from the power supply unit 21 into a power supply voltage (for example, 3 V) of the power supply control microcomputer 24, and supplies the power supply voltage.

The PCIe bridge controller 23 controls communication among the platforms 12-1 to 12-7.

In such a case, similarly to the switching IC 25-2 to the switching 25-7, the switching IC 25-1 is also placed under the control of the power supply control microcomputer and performs power supply and shut-off with respect to the PCIe bridge controller 23.

As described above, since the platforms 12-1 to 12-7 have the control units SoC1 to SoC7, respectively, each of the platforms 12-1 to 12-7 is configured as a board-type computer (information processing device) including a memory, such as a micro processing unit (MPU), a read only memory (ROM), and a random access (RAM), and various input/output interfaces (I/O interfaces).

The platform 12-1 is installed with, for example, Windows as an OS, and manages and supervises the other platforms 12-2 to 12-7.

The platforms 12-2 to 12-7 perform processing under the control of the platform 12-1 independently or in cooperation with other platforms, and transmit processing results to a platform that performs processing of a next stage or the platform 12-1 as required or according to previous setting.

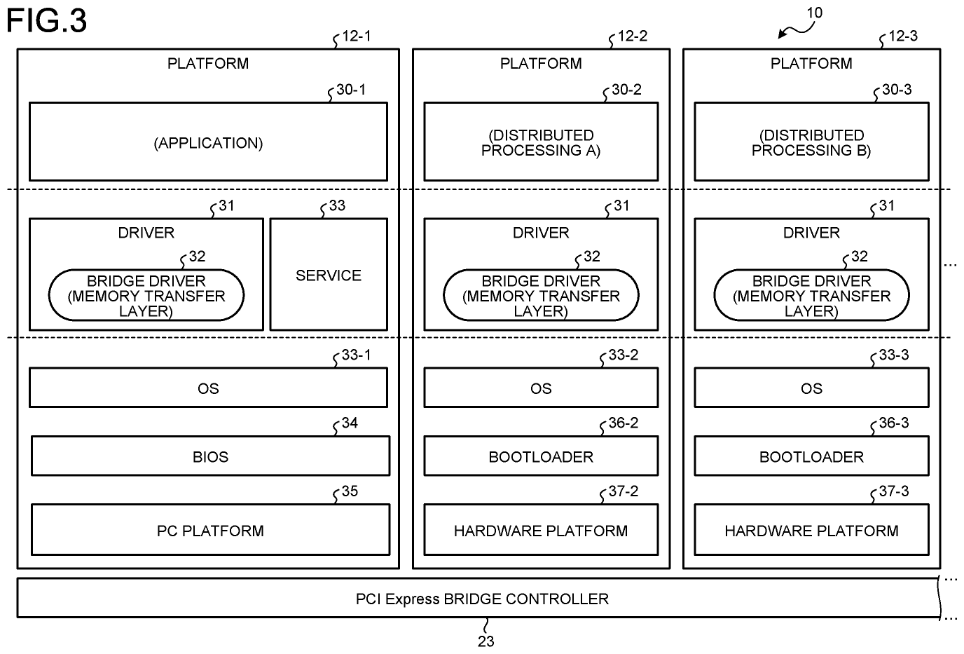

FIG. 3 is an explanatory diagram of a software configuration example of a platform.

MPUs provided in a platform 12-1 to a platform 12-7 may be provided by vendors different from one another.

The platform 12-1 performs various processes under the control of an application program 30-1.

A basic input output system (BIOS) 34 for starting up a bootloader is embedded in the platform 12-1. The bootloader detects and starts up an OS 33-1 (for example, Windows).

In this way, the OS 33-1 reads various drivers 31 including a bridge driver 32 for controlling a PCIe bridge controller 23, electrically accesses the PCIe bridge controller 23 via the bridge driver 32 and a PC platform 37-2, and communicates with the other platforms 12-2 to 12-7, thereby performing actual processing.

Next, the platforms 12-2 to 12-7 will be described.

Since the platforms 12-2 to 12-7 have the same configuration, the platform 12-2 will be described as an example.

The platform 12-2 performs various processes under the control of an application program 30-2.

A bootloader 36-2 is embedded in the platform 12-2, detects an OS 33-2 (for example, Linux; registered trademark) by the bootloader, and starts up the OS 33-2.

In this way, the OS 33-2 reads a bridge driver 32 for controlling the PCIe bridge controller 23, electrically accesses the PCIe bridge controller 23 via the bridge driver 32 and a hardware platform 37-2, and communicates with the other platforms 12-1, and 12-3 to 12-7, thereby performing actual processing.

Furthermore, in the aforementioned configuration, the platforms 12-1 to 12-7 are configured to be independently operable so as not to affect other driver configurations, respectively.

Next, an operation of the embodiment will be described.

First, processing at the time of start-up via the LAN (what is called a WoL: Wake up On Lan) will be described.

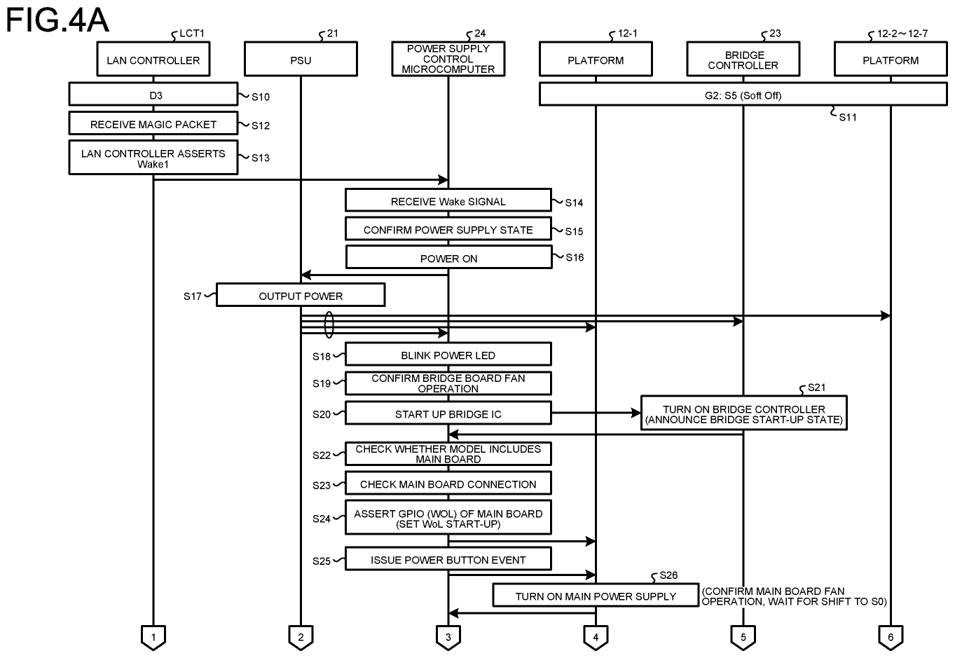

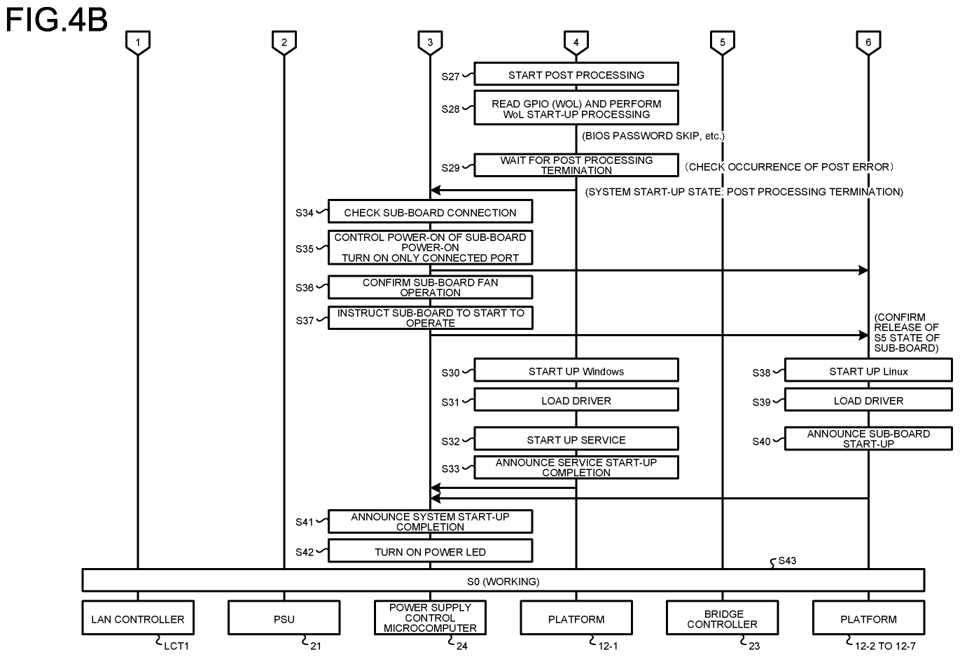

FIG. 4A is a diagram (part 1) for explaining an example of a processing sequence flowchart at the time of start-up processing via the LAN of the embodiment.

Furthermore, FIG. 4B is a diagram (part 2) for explaining the example of the processing sequence flowchart at the time of the start-up processing via the LAN of the embodiment.

As illustrated in FIG. 4A, in an initial state, it is assumed that the LAN connector LC1 is in a sleep mode (D3 state) (step S10), the power supply unit 21 and the power supply control microcomputer 24 are in a standby state (low power consumption mode), and the platform 12-1, the PCIe bridge controller 23, and the platforms 12-2 to 12-7 are in a non-working state (Soft off) (S5 state) (step S11).

It is assumed that the LAN controller LCT1 receives what is called a magic packet MGP from the local area network LAN1 via the LAN connector LC1 (step S12).

In this way, the LAN controller LCT1 transmits a wake-on-LAN signal wake1 to the power supply control microcomputer 24 (step S13).

When the wake-on-LAN request packet wake1 is received in the standby state (step S14), the power supply control microcomputer 24 confirms a power supply state (step S15).

Subsequently, the power supply control microcomputer 24 sends a power-on command for instructing the start of supply of predetermined power (for example, DC 12 V) to the power supply unit 21 (step S16).

In this way, the power supply unit 21 starts the supply of the predetermined power to the power supply control microcomputer 24, the platform 12-1, and the PCIe bridge controller 23 (step S17).

Accordingly, the power supply control microcomputer 24 causes a power LED (a power indicator, not illustrated) to be in a blinking state (step S18), and confirms whether a fan (bridge board fan) of the bridge board 11, which is a board on which the power supply control microcomputer 24 and the PCIe bridge controller 23 are installed, is operating normally (step S19).

In the process of step S19, when the fan of the bridge board is operating normally, the power supply control microcomputer 24 starts up a bridge IC (not illustrated) (step S20).

In this way, the PCIe bridge controller 23 shifts to an on state (operating state) and notifies the power supply control microcomputer 24 of a bridge start-up state (step S21).

In this way, the power supply control microcomputer 24 determines whether the model includes the platform 12-1 (denoted as a main board in the drawing) exists (step S22).

In the case of the model in which the platform 12-1 exists, the power supply control microcomputer 24 checks the connection state of the platform 12-1 (step S23), and sets a wake-on-LAN signal of general purpose input/output (GPIO) of the platform 12-1 to be active and set the wake-on-LAN signal in wake-on-LAN start-up (step S24).

Then, the power supply control microcomputer 24 issues a power button event to the platform 12-1 (step S25).

In this way, the platform 12-1 shifts to a power-on state (step S26), confirms a main board fan operation, and enters a state of waiting for shift to a working state (S0).

Subsequently, the platform 12-1 starts power-on self-test (POST) processing (step S27).

Subsequently, as illustrated in FIG. 4B, the platform 12-1 confirms that the wake-on-LAN signal is active with reference to the GPIO and shifts to wake-on-LAN start-up processing (step S28).

Moreover, the platform 12-1 shifts to a state of waiting for a POST processing completion and determines whether a POST error has occurred. When no POST error has occurred, the platform 12-1 shifts to a system start-up state, terminates the POST processing, and notifies the power supply control microcomputer 24 of the system start-up state and the POST processing termination (step S29).

Then, the platform 12-1 starts up the OS (for example, Windows) (step S30) and loads a driver (step S31).

Moreover, the platform 12-1 starts up a predetermined service 33 (step S32), and when the start-up of the service 33 is completed, the platform 12-1 notifies the power supply control microcomputer 24 of the service start-up completion (step S33).

On the other hand, the power supply control microcomputer 24, which has detected that the platform 12-1 has shifted to the system start-up state by the notification of step S29, checks the connection state of the platforms 12-2 to 12-7 (denoted as sub-boards in the drawing) (step S34), and performs power-on control of each of the platforms 12-2 to 12-7 (step S35). Specifically, only connected ports are powered on.

Subsequently, the power supply control microcomputer 24 confirms whether fans of the platforms 12-2 to 12-7 are operating normally (step S36) and instructs the platforms 12-2 to 12-7, of which the fans are operating normally, to start to operate (step S37).

In this way, the platforms 12-2 to 12-7 starts up the OS (for example, Linux) (step S38) and loads drivers (step S39).

Moreover, when the start-up is completed, the platforms 12-2 to 12-7 notify the power supply control microcomputer 24 of the start-up completion (step S40).

As a consequence, when the power supply control microcomputer 24 confirms that the system start-up has been completed by the start-up of the platform 12-1 and the platforms 12-2 to 12-7 (step S41), the power supply control microcomputer 24 shifts the power LED to a lighting state (step S42).

As a consequence, the power supply unit 21, the power supply control microcomputer 24, the platform 12-1, the PCIe bridge controller 23, and the platforms 12-2 to 12-7 shift to a normal working state (S0 state).

As described above, according to the present embodiment, even when a wake-on-LAN start-up packet received from an external LAN network via the LAN controller LCT1, what is called a magic packet MGP is received, the power supply control microcomputer 24 can start up the information processing system 10 by the same procedure as when manual start-up is performed by pressing the power button, can make the start-up sequence constant regardless of a start-up method, and can improve the reliability of the start-up of the information processing system 10.

At this time, since the power supply control microcomputer 24 controls the start-up, the information processing system 10 can be started up after the supply of power is stabilized, so that the platforms 12-1 to 12-7 can be reliably started up and the entire information processing system 10 can be reliably started up.

The disclosed technology is not limited to the aforementioned embodiment and various modifications can be made without departing from the scope of the present embodiment. Each configuration and each processing of the present embodiment can be selected as needed or may be appropriately combined.

For example, in the above description, the case where all the platforms 12-1 to 12-7 are started up has been described. However, in the LAN controller LCT1 and the LAN controller LCT2, a general magic packet MGP (=a packet including a broadcast address+a MAC address of the LAN connector a plurality of number of times or more or a packet including an IP address+the MAC address of the LAN connector a plurality of number of times or more) is configured to be able to process pseudo magic packets having different formats, so that it is also possible to start up one or a plurality of specific platforms (for example, only the platform 12-1 or only the platform 12-1 and the platform 12-3).

In such a case, as a configuration in which the pseudo magic packet includes, for example, the broadcast address+the MAC address of the LAN connector a plurality of number of times or more and is allowed to include ID data for specifying a platform, which is an information processing device to be started up, it may be possible to employ a configuration in which it is possible to notify the power supply control microcomputer 24 of the ID data or start-up target-specific data corresponding to the ID data.

By employing such a configuration, when performing maintenance and the like, it is possible to start up only a platform (information processing device) to be subjected to maintenance and to perform processing.

Furthermore, in the configuration illustrated in FIG. 2, the seven platforms 12-1 to 12-7 can be connected to the PCIe bridge controller 23; however, the present invention is not limited thereto and the PCIe bridge controller 23 may also include six or less or eight or more platforms.

Furthermore, in the aforementioned embodiment, the communication system using the PCI express has been described; however, the present invention is not limited thereto and may also be applied to communication using communication standards other than the PCI express.

Furthermore, according to the aforementioned disclosure, the present embodiment can be embodied and manufactured by a person skilled in the art.

Regarding the above embodiment, other aspects will be further described.

[1] First Other Aspect

An information processing system of a first other aspect of the embodiment is an information processing system including a plurality of information processing devices each including a processor, a relay device that is able to connect the plurality of information processing devices via an expansion bus and relays communication between the plurality of information processing devices, and a local area network (LAN) controller operatively coupled to at least one of the plurality of information processing devices and connectable to a LAN, in which the relay device includes a power supply controller that controls the supply of power to the plurality of information processing devices and performs start-up control of the plurality of information processing devices in response to receiving a wake-on-LAN instruction from the LAN via the LAN controller.

According to the aforementioned configuration, the power supply controller controls the supply of the power to the plurality of information processing devices and performs the start-up control of the plurality of information processing devices in response to receiving the wake-on-LAN instruction from the LAN via the LAN controller. Therefore, even when the start-up is performed by the wake-on-LAN, it is possible to stably perform start-up processing in the same manner as when the start-up is performed by pressing a power button, without being affected by a system configuration.

[2] Second Other Aspect

An information processing system of a second other aspect of the embodiment is the information processing system in the first other aspect, in which the power supply controller stabilizes the supply of the power to the plurality of information processing devices prior to the start-up control.

According to the aforementioned configuration, since the supply of the power is reliably stabilized before the start-up control, the information processing system can be started up reliably and stably.

[3] Third Other Aspect

An information processing system of a third other aspect of the embodiment is the information processing system in the first other aspect or the second other aspect, in which the relay device includes a power button for performing instruction operations for power supply and shutdown, and in response to receiving a wake-on-LAN instruction, the power supply controller performs the start-up control in the same procedure as when the start-up control is performed by the power button.

According to the aforementioned configuration, the power supply controller performs the same operation between in response to the power button being operated and in response to receiving the wake-on-LAN instruction from the LAN via the LAN controller. Therefore, even when the start-up is performed by the wake-on-LAN, it is possible to stably perform the start-up processing in the same manner as when the start-up is performed by pressing the power button without being affected by the system configuration.

[4] Fourth Other Aspect

An information processing system of a fourth other aspect of the embodiment is the information processing system in the first to third other aspects, in which the plurality of information processing devices include a first information processing device serving as a root complex and a second information processing device serving as an endpoint, and when the power supply controller performs the start-up control on all the plurality of information processing devices, the power supply controller first performs the start-up control on the first information processing device and performs the start-up control on the second information processing device in response to detecting normal start-up of the first information processing device.

According to the aforementioned configuration, when the information processing system includes the first information processing device serving as the root complex and the second information processing device serving as the endpoint, since the second information processing device serving as the endpoint is started up after the start-up of the first information processing device serving as the root complex to be first started up, the entire information processing system can be started up stably and reliably.

[5] Fifth Other Aspect

An information processing system of a fifth other aspect of the embodiment is the information processing system in the fourth other aspect, in which the LAN controller is operatively coupled to only the first information processing device.

According to the aforementioned configuration, since the information processing system is recognized as one information processing apparatus when viewed from the LAN, it is possible to start up the information processing system without going through a complicated processing procedure.

[6] Sixth Other Aspect

A relay device of a sixth other aspect of the embodiment is a relay device that is able to connect a plurality of information processing devices via an expansion bus and relays communication between the plurality of information processing devices, in which the relay device includes a bridge controller that controls the relay of the communication between the plurality of information processing devices, and a power supply controller that controls the supply of power to the bridge controller, controls the supply of the power to the plurality of information processing devices, and then performs start-up control of the plurality of information processing devices in response to receiving a wake-on-LAN instruction from a LAN via an external LAN controller.

According to the aforementioned configuration, since transition to the start-up control is performed after the supply of the power and communication states of the plurality of information processing devices are reliably stabilized, the information processing system can be started up reliably and stably.

According to an aspect of the present disclosure, since the power supply controller controls the supply of the power to the plurality of information processing devices and performs the start-up control of the plurality of information processing devices in response to receiving the wake-on-LAN instruction from the LAN via the LAN connector, even when the start-up is performed by the wake-on-LAN, it is possible to stably perform start-up processing in the same manner as when the start-up is performed by pressing the power button, without being affected by a system configuration.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprising:
a plurality of information processing devices each including a processor;
a relay device that connects the plurality of information processing devices via an expansion bus and relays communication between the plurality of information processing devices; and
a local area network (LAN) controller operatively coupled to at least one of the plurality of information processing devices and connectable to a LAN, wherein
the relay device comprises a power supply controller that controls supply of power to the plurality of information processing devices and performs start-up control of the plurality of information processing devices in response to receiving a wake-on-LAN instruction from the LAN via the LAN controller.

2. The information processing system according to claim 1, wherein the power supply controller stabilizes the supply of the power to the plurality of information processing devices prior to the start-up control.

3. The information processing system according to claim 1, wherein
the relay device comprises a power button for power supply and shutdown, and
in response to receiving a wake-on-LAN instruction, the power supply controller performs the start-up control in a same procedure as when the start-up control is performed by the power button.

4. The information processing system according to claim 1, wherein the plurality of information processing devices comprises:
a first information processing device as a root complex; and
a second information processing device as an endpoint, and
when the power supply controller performs the start-up control on all the plurality of information processing devices, the power supply controller first performs the start-up control on the first information processing device and performs the start-up control on the second information processing device in response to detecting normal start-up of the first information processing device.

5. The information processing system according to claim 4, wherein the LAN controller is operatively coupled to only the first information processing device.

6. A relay device that connects a plurality of information processing devices via an expansion bus and relays communication between the plurality of information processing devices, the relay device comprising:
a bridge controller that controls relay of the communication between the plurality of information processing devices; and
a power supply controller that controls supply of power to the bridge controller, controls supply of power to the plurality of information processing devices, and then performs start-up control of the plurality of information processing devices in response to receiving a wake-on-LAN instruction from a LAN via an external LAN controller.
